(19) United States
(12) Patent Application Publication
(10) Pub. No.: US 2012/0315360 A1
(43) Pub. Date: Dec. 13, 2012

(54) COTTON CANDY AND MANUFACTURING METHOD THEREOF

(76) Inventor: Jeongmin YOON, Anyang-si (KR)

(21) Appl. No.: 13/154,758

(22) Filed: Jun. 7, 2011

(51) Int. Cl. A23G 3/54; A23G 3/36

(52) U.S. Cl. 426/98; 426/660

(57) ABSTRACT

The invention provides a cotton candy and a manufacturing method thereof, and the cotton candy according to the invention includes: a cotton candy body which is formed in a manner such that sugar solution formed by melting sugar is drawn out or sprayed in a fiber shape and is cooled; and a plurality of candy particles which is scattered inside the cotton candy body, wherein one or more of the cotton candy body and the candy particles contain an edible fatty matter, and the plurality of candy particles is fixed to the cotton candy body by adhesiveness of the fatty matter so as not to be separated therefrom.

According to the invention, since the plurality of sugar particles is scattered in the cotton candy body, it is possible to enjoy high-quality taste and unusual texture obtained by the harmony between the cotton candy body and the sugar particles when eating the cotton candy. Since one or more of the cotton candy body and the sugar particles contain the fatty matter, the plurality of sugar particles is fixed to the cotton candy body through adhesiveness thereof while being evenly scattered inside the cotton candy body. Accordingly, since it is possible to prevent the plurality of sugar particles from being separated from the cotton candy body so that they are not biased in a predetermined direction during the distribution of the cotton candy, it is possible to normally maintain the high product quality. Also, since it is possible to effectively prevent the sugar particles from being separated from the cotton candy body so that they are not dropped therefrom while eating the cotton candy, it is possible to enjoy the taste and texture obtained by the harmony between the cotton candy body and the sugar particles throughout the eating time and effectively prevent the eating space from being messed up by the sugar particles dropped thereto.

### BACKGROUND OF THE INVENTION

1. Field of the Invention

The present invention relates to a cotton candy and a manufacturing method thereof, and more particularly, to a cotton candy making unusual high-quality taste and texture at the time of eating the cotton candy, maintaining the high product quality even at the time of distributing the cotton candy, making balanced taste and texture throughout the eating time, and preventing the eating space from being messed up and a manufacturing method thereof.

2. Description of the Related Art

In general, a cotton candy is a candy with sweet taste and smooth texture, and is manufactured in a manner such that sugar solution formed by melting sugar is drawn out or sprayed from a minute nozzle using a centrifugal force or an air pressure, the drawn or sprayed sugar solution is cooled in the atmosphere to be formed as a fiber-like cotton candy body, and the cotton candy body is massed by a predetermined unit and is wrapped around sanitary chopsticks or the like.

Such a cotton candy has been steadily loved by a lot of children and aged persons due to the sweetness of sugar and the smooth texture thereof, but there is a problem that the sweet smooth texture may be easily sick due to its very monotonous texture.

In order to solve such a problem, there has been attempted to manufacture a cotton candy with various tastes and textures by adding particles with chewing texture and various tastes and flavors to a cotton candy body formed in a fiber shape.

However, in the case of the cotton candy manufactured by simply adding a plurality of particles to the cotton candy body, the plurality of particles cannot be stably fixed to the cotton candy body, so that there is a problem that the plurality of particles is separated from the cotton candy body and is biased in a predetermined direction inside a package when the cotton candy is distributed inside the package.

Since the plurality of particles is separated from the cotton candy body, the high product quality cannot be maintained during the distribution of the cotton candy. Then, when a person eats the cotton candy in which the plurality of particles is separated from the cotton candy body, the person only separately eats the cotton candy with the existing monotonous texture and taste and the particles with various tastes and flavors.

Further, when the plurality of particles is easily separated from the cotton candy body in this manner, there is a problem that the particles are separated and dropped from the cotton candy body while the person eats the cotton candy, so that the eating space is messed up by the particles. In particular, when taking into consideration of the fact that the cotton candy is a personal preferred item which is frequently taken by carless children and aged persons, the problem that the eating space is messed up by the particles dropped thereto may be more magnified.

### SUMMARY OF THE INVENTION

The invention is made in view of such circumstances, and an object thereof is to provide a cotton candy which contains particles making unusual high-quality taste and texture and in which particles are strongly fixed to a cotton candy body so that the particles are not separated from the smooth fiber-like cotton candy body at the time of distributing or eating the cotton candy even when the particles are contained therein and a manufacturing method thereof.

In order to solve the above-described problems, according to one aspect of the invention, there is provided a cotton candy including: a cotton candy body which is formed in a manner such that sugar solution formed by melting sugar is drawn out or sprayed in a fiber shape and is cooled; and a plurality of candy particles which is scattered inside the cotton candy body, wherein one or more of the cotton candy body and the candy particles contain an edible fatty matter, and the plurality of candy particles is fixed to the cotton candy body by adhesiveness of the fatty matter so as not to be separated therefrom.

The fatty matter may be coated on the outer peripheral surfaces of the plurality of candy particles when the fatty matter is contained in the plurality of candy particles.

The fatty matter may be coated on the outer peripheral surfaces of the plurality of candy particles in the form of a liquid intermediate formed by mixing a predetermined edible matter with the fatty matter when the fatty matter is contained in the plurality of candy particles.

The plurality of candy particles may be provided as a plurality of carbonated candy particles formed by mixing carbon dioxide with the candy particles so as to generate carbon dioxide when contacting moisture.

The cotton candy body may be compressed and cut in a sheet shape with a predetermined thickness.

The fatty matter may be contained in the cotton candy body and the plurality of candy particles by 5 wt % to 10 wt %.

According to another aspect of the invention, there is provided a method of manufacturing a cotton candy, including: forming sugar solution by melting sugar; adding an edible fatty matter to a plurality of candy particles; and forming a cotton candy by inputting the plurality of candy particles to the sugar solution drawn out from a minute hole in a fiber shape or sprayed from a rotary disc.

The method of manufacturing the cotton candy may further include adding the fatty matter to the sugar or the sugar solution.

The adding the fatty matter to the plurality of candy particles is coating the fatty matter on the plurality of candy particles.

The adding the fatty matter to the plurality of candy particles may be coating the fatty matter on the plurality of candy particles in the form of a liquid intermediate formed by mixing the fatty matter with a predetermined edible matter.

The forming the cotton candy may be forming the cotton candy by inputting the plurality of candy particles to the sugar solution drawn out from the minute hole in connection with a bent passage.

The method of manufacturing the cotton candy may further include compressing and cutting the cotton candy in a sheet shape with a predetermined thickness.

The fatty matter may be added to the cotton candy by 5 wt % to 10 wt %.

According to still another aspect of the invention, there is provided a method of manufacturing a cotton candy, including: adding an edible fatty matter to sugar; forming sugar solution by melting the sugar; and forming a cotton candy by inputting the plurality of candy particles to the sugar solution drawn out from a minute hole in a fiber shape or sprayed from a rotary disc.

According to still another aspect of the invention, there is provided a method of manufacturing a cotton candy, including: forming sugar solution by melting sugar; adding an edible fatty matter to the sugar solution; and forming a cotton candy by inputting the plurality of candy particles to the sugar solution drawn out from a minute hole in a fiber shape or sprayed from a rotary disc.

According to the cotton candy and the manufacturing method thereof of the invention, since the plurality of candy particles is evenly scattered in the cotton candy body to be contrasted with the smooth texture of the cotton candy body, it is possible to enjoy high-quality taste and unusual texture obtained by the harmony between the cotton candy body and the sugar particles when eating the cotton candy.

In particular, when the plurality of candy particles is provided as the plurality of carbonated candy particles generating carbon dioxide when contacting moisture, it is possible to provide refreshment and peculiar texture to the user due to the generation of carbon dioxide when eating the cotton candy.

Further, since one or more of the cotton candy body and the candy particles contain the fatty matter, the plurality of candy particles may be stably fixed to the cotton candy body by adhesiveness of the fatty matter while being scattered inside the cotton candy body. Then, since the cotton candy body is compressed and cut in a sheet shape with a predetermined thickness, the plurality of candy particles may be more stably fixed into the cotton candy body.

Accordingly, since it is possible to prevent the plurality of sugar particles from being separated from the cotton candy body so that they are not biased in a predetermined direction during the distribution of the cotton candy, it is possible to normally maintain the high product quality so that the plurality of candy particles is evenly distributed inside the cotton candy body.

In addition, since it is possible to effectively prevent the sugar particles from being separated from the cotton candy body so that they are not dropped therefrom while eating the cotton candy, it is possible to enjoy the taste and texture obtained by the harmony between the cotton candy body and the sugar particles throughout the eating time and effectively prevent the eating space from being messed up by the sugar particles dropped thereto.

Furthermore, since the sugar solution passes through the bent passage and is drawn out from the minute hole when the cotton candy is manufactured, the smoother cotton candy body may be formed. Accordingly, it is possible to provide the further improved texture obtained by the harmony between the smoothness of the cotton candy body and the stimulus of the candy particles.

### BRIEF DESCRIPTION OF THE DRAWINGS

FIG. 1 is a flowchart illustrating a method of manufacturing a cotton candy according to the preferred embodiment of the invention.

FIG. 2 is a diagram schematically illustrating the method of manufacturing the cotton candy according to the preferred embodiment of the invention.

FIG. 3 is a diagram schematically illustrating a cross-section taken along the line A-A shown in FIG. 2.

### DETAILED DESCRIPTION OF THE PREFERRED EMBODIMENTS

Hereinafter, an embodiment of the invention will be specifically described by referring to the accompanying drawings so that the person (hereinafter, referred to as an “ordinary-skilled person of the art”) having general knowledge in the technical field to which the invention belongs can easily implement the invention. However, the invention may be realized in various different forms, and the scope thereof is not limited to the embodiment to be described herein.

Hereinafter, the configuration and the effect of a cotton candy according to the preferred embodiment of the invention will be specifically described.

The cotton candy according to the preferred embodiment of the invention includes a cotton candy body and a plurality of candy particles. Here, the cotton candy body is a fiber-like intermediate which is formed in a manner such that sugar solution is drawn out from a minute hole or is sprayed from a rotary disc and is cooled, and the cotton candy is defined as a finished product which is finally packed.

The cotton candy body is a smooth fiber-like material which is formed in a manner such that sugar solution obtained by heating and melting sugar containing an edible fatty matter such as palm oil, olive oil, and soybean oil from 180° C. to 200° C. is drawn out or sprayed from a minute hole using a centrifugal force or an air pressure under the condition with low humidity and the drawn or sprayed sugar solution is cooled at the atmosphere.

Here, when the temperature of the sugar solution is less than 180° C., sugar having a melting point of about 185° C. may not be sufficiently melted as a whole. When the temperature of the sugar solution becomes more than 200° C., sugar may be carbonized, so that a browing reaction is generated. In this case, since the fiber-like cotton candy body may not be satisfactorily formed due to the extremely decreased viscosity, it is idealistic that the temperature of the sugar solution is from about 180° C. to 200° C.

Then, it is desirable that the cotton candy body is formed in a manner such that sugar solution passes through a bent passage and is drawn out and cooled in a fiber shape from a minute hole in connection with the passage. When the cotton candy body is formed in a manner such that the sugar solution passes through the passage and is drawn out from the minute hole, a cotton candy body is formed which has smoother texture due to a reason that minute sugar particles which are not melted enough and are contained in the sugar solution are suppressed from being drawn out from the minute hole. That is, the harmony of contrasting texture between smooth texture of the cotton candy body and stimulating texture of the candy particles may be more sensed.

The fatty matter is a matter that stably fixes a plurality of candy particles to the cotton candy body through adhesiveness thereof so that the candy particles are scattered. As described above, the fatty matter may be added to sugar before sugar solution is formed, and be added to sugar solution formed by melting sugar.

The plurality of candy particles is formed by coating a plurality of carbonated candy particles, produced by mixing carbon dioxide with candy, with a fatty matter as described above. Since the candy particles generate carbon dioxide while being scattered inside the cotton candy body and melted inside a mouth of a person eating the cotton candy, the person may sense refreshment as well as popping sound and sensation.

The fatty matter coated on the plurality of candy particles serves to stably fix the plurality of candy particles to the cotton candy body by adhesiveness thereof as in the fatty matter contained in the cotton candy body.

It is desirable that the fatty matter is contained in the cotton candy body and the plurality of candy particles by 5 wt % to 10 wt % with respect to the cotton candy body and the plurality of candy particles.

The reason is as follows. When the fatty matter is contained to be less than 5 wt %, the adhesiveness thereof cannot be sufficiently exhibited, so that the plurality of candy particles may not be stably fixed to the cotton candy body. When the fatty matter is contained to be more than 10 wt %, the greasy flavor and taste of the fatty matter may be transmitted to the person eating the cotton candy.

In the preferred embodiment of the invention, the plurality of candy particles is provided as a plurality of carbonated candy particles coated with a fatty matter, but the invention is not limited thereto. For example, the plurality of candy particles may be provided as crystalline candy particles or granular particles coated with a fatty matter, and a plurality of these various kinds of candy particles may be complexly provided.

On the other hand, a case has been described in which each of the cotton candy body and the plurality of candy particles provided in the cotton candy according to the preferred embodiment of the invention contains a fatty matter. However, even when only one of the cotton candy body and the plurality of candy particles contains a fatty matter, the plurality of candy particles may be fixed to the cotton candy body to be scattered therein.

Further, in order to maximize the effect in which the plurality of candy particles is stably fixed to the cotton candy body, the plurality of candy particles is made so that the outer peripheral surface thereof is coated with a fatty matter. However, the plurality of candy particles may not essentially contain the fatty matter in a manner of coating the outer peripheral surface of the plurality of candy particles with the fatty matter, and the above-described effect may be sufficiently exhibited even when the fatty matter is contained in the candy particles in a manner of being mixed therewith.

In addition, the form of containing the fatty matter in the plurality of candy particles is not limited to that only the fatty matter is coated on the candy particles. For example, the fatty matter may be coated on the outer peripheral surfaces of the plurality of candy particles in the form of a liquid artificial product such as liquid chocolate formed by mixing a predetermined edible matter with the fatty matter.

Then, the plurality of candy particles may be provided to have various sizes in accordance with the texture or the taste to be applied to the cotton candy, and the wt % with respect to the cotton candy body may be very variously determined.

Since the plurality of candy particles may be stably fixed to the cotton candy body due to the fatty matter contained in the plurality of candy particles and the cotton candy body even when the plurality of candy particles is provided to have a big size of 5 mm or more and the candy particles are contained to have 50 wt % or more with respect to the cotton candy body, there is no concern about degradation of quality in which the candy particles are separated from the cotton candy body regardless of the size or the content of the candy particle.

On the other hand, the cotton candy according to the preferred embodiment of the invention is formed as a sheet shape in a manner such that the cotton candy body containing the plurality of scattered candy particles is compressed and cut into a predetermined thickness.

When the cotton candy body is compressed to a certain extent, it is desirable in that the interior of the fiber-like cotton candy body becomes more densely concentrated to further improve the effect of fixing the plurality of candy particles using the fatty matter and a comparatively large amount of cotton candy may be inserted into a package container with a limited size.

In this manner, since the plurality of candy particles for allowing the cotton candy to have high-quality texture and various tastes are fixed into the cotton candy body to be scattered therein, it is possible to effectively prevent the quality of the product from being degraded or prevent a place used for eating the cotton candy from being messed up due to the separation of the plurality of candy particles when distributing or eating the cotton candy.

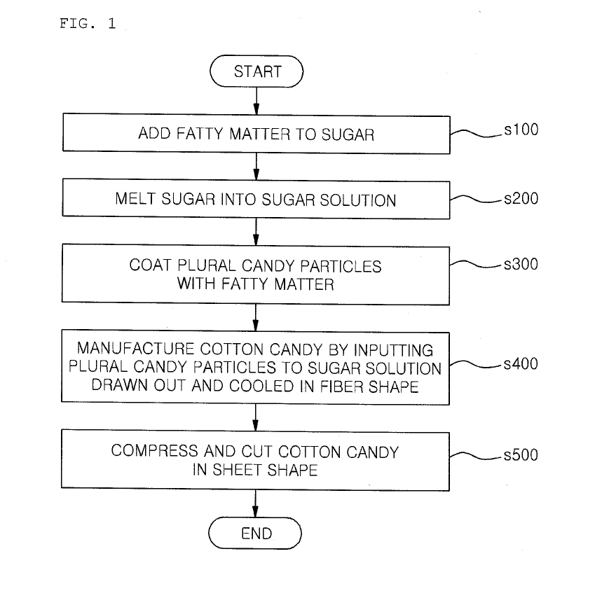

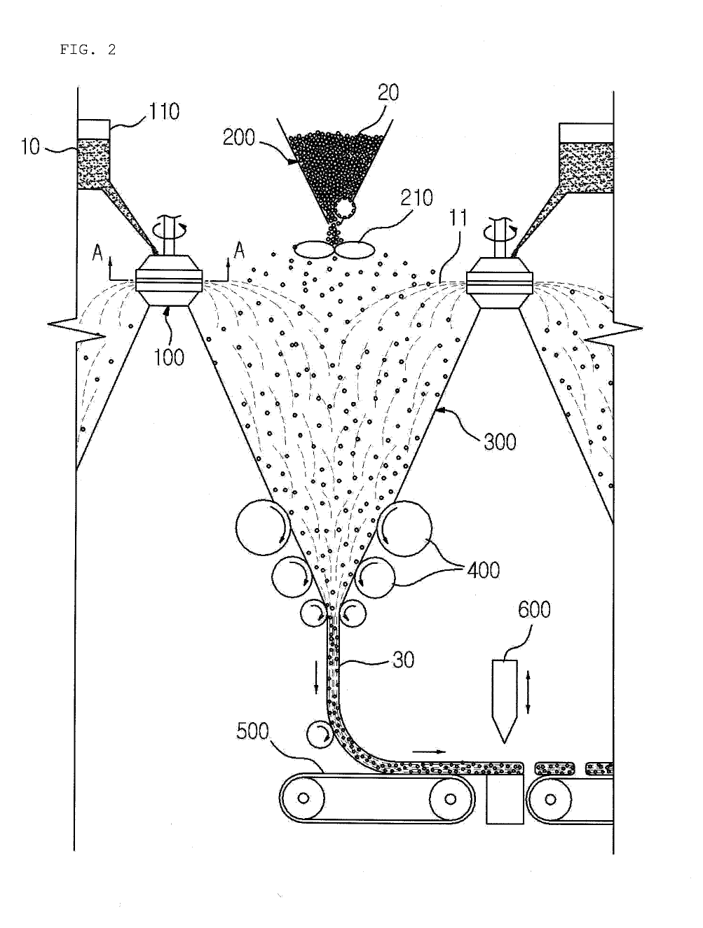

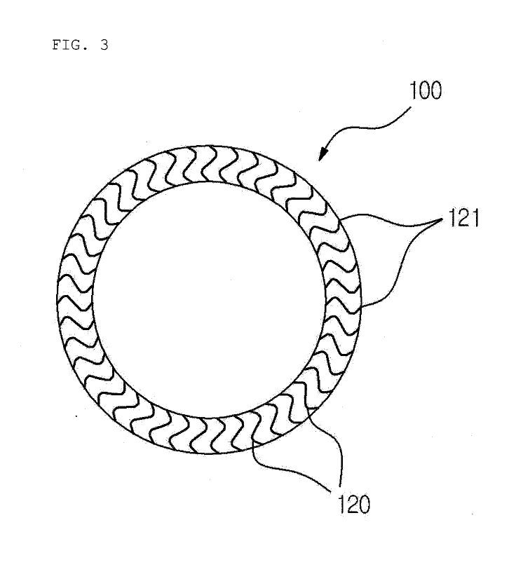

Hereinafter, a method of manufacturing cotton candy according to the preferred embodiment of the invention will be specifically described by referring to FIGS. 1 to 3. FIG. 1 is a flowchart illustrating a method of manufacturing cotton candy according to the preferred embodiment of the invention, and FIGS. 2 and 3 are diagrams illustrating a cotton candy manufacturing apparatus that is used to describe the method of manufacturing the cotton candy.

First, an edible fatty matter such as palm oil, olive oil, and soybean oil is added to sugar 10 which is a raw material of a cotton candy body 11 (s100). This operation may be conducted in a manner such that the fatty matter is sprayed to the sugar 10 which is being mixed. The sugar 10 having the fatty matter added thereto is received in a sugar supply unit 110.

Next, the sugar 10 having the fatty matter added thereto is heated from 180° C. to 200° C. to be melted into sugar solution (s200). Through such a melting operation, the sugar supply unit 110 supplies the sugar 10 to a cotton candy body manufacturing unit 100, and a heater (not shown) which is separately provided melts the sugar 10 received in the cotton candy body manufacturing unit 100.

On the other hand, a plurality of sugar particles 20 to be scattered inside the cotton candy body 11 is coated with the above-described fatty matter (s300). Such a coating operation may be conducted in a manner such that the plurality of sugar particles 20 inserted into a mesh is temporarily immersed in the fatty matter or the fatty matter is sprayed to the plurality of sugar particles 20 using a sprayer and the fatty matter excessively adhering to the sugar particles 20 is dropped by gravity.

Here, it is desirable that the fatty matter is contained in the cotton candy body 11 and the plurality of sugar particles 20 by 5 wt % to 10 wt % with respect to the cotton candy body 11 and the plurality of sugar particles 20.

The reason is as follows. The fatty matter is added to stably fix the plurality of sugar particles 20 to the cotton candy body 11 by adhesiveness thereof. When the fatty matter is contained to be less than 5 wt %, the adhesiveness thereof cannot be sufficiently exhibited, so that the plurality of candy particles 20 may not be stably fixed to the cotton candy body 11. When the fatty matter is contained to be more than 10 wt %, the greasy flavor and taste of the fatty matter may be transmitted to the person eating the cotton candy.

When the fatty matter is contained in the plurality of sugar particles 20, the fatty matter may be contacted on the outer peripheral surfaces of the plurality of sugar particles 20 in the form of a liquid artificial product such as liquid chocolate formed by mixing a predetermined edible matter with the fatty matter.

The sugar particles 20 having the fatty matter added thereto are received in the sugar supply unit 200.

Subsequently, the above-described sugar solution is drawn out from a minute hole or sprayed from a rotary disc by using a centrifugal force or an air pressure under a condition with low humidity and the plurality of sugar particles 20 is scattered, thereby manufacturing cotton candy 30 having the plurality of sugar particles 20 scattered in the cotton candy body 11 which is formed in a fiber shape from the drawn and sprayed sugar solution (s400).

Specifically, when the cotton candy body manufacturing unit receiving sugar solution therein as shown in FIG. 2 rotates fast, the sugar solution is drawn out in a fiber shape from a minute hole 121 which is formed at the side portion of the cotton candy body manufacturing unit by a centrifugal force thereof, and the drawn sugar solution is formed as the cotton candy body 11 while being cooled in a manner of contacting air with a normal temperature. At this time, the sugar supply unit 200 inputs a constant amount of sugar particles 20 per unit time, and a spreader 210 provided below the sugar supply unit 200 evenly scatters the input sugar particles 20 into the cotton candy body 11.

At this time, the plurality of sugar particles 20 is stably fixed into the cotton candy body 11 to be evenly scattered therein by adhesiveness of the fatty matter contained in the cotton candy body 11 and the plurality of sugar particles 20.

On the other hand, as shown in FIG. 3, since the minute hole 121 provided at the side portion of the cotton candy body manufacturing unit 100 is provided to be in connection with the interior of the cotton candy body manufacturing unit 100 receiving sugar solution therein via a bent passage 120, the sugar solution passes through the passage 120 and then is drawn out from the minute hole 121, thereby forming the cotton candy body 11.

Accordingly, the cotton candy body 11 may be formed which has smoother texture due to a reason that minute sugar particles which are not melted enough and are contained in the sugar solution are suppressed from being drawn out from the minute hole 121.

In the description of the preferred embodiment of the invention, the spreader 210 is provider below the sugar supply unit 200 to scatter the sugar particles 20. However, the sugar supply unit 200 may be configured to have a plurality of positions of inputting the sugar particles 20 from the sugar supply unit 200 and the separate spreader 210 may not be provided.

Subsequently, as shown in FIG. 2, the cotton candy 30 manufactured in this manner is compressed and cut in a sheet shape with a predetermined thickness (s500). The cotton candy 30 is gradually compressed by a funnel shape of the hopper 30 as it goes to the lower side of the hopper 300, and is compressed in a sheet shape with a predetermined thickness while passing through compressing rollers 400.

Through such a compressing operation, the interior of the fiber-like cotton candy body 11 becomes more densely concentrated to further improve the effect of fixing the plurality of sugar particles 20 using the fatty matter.

The cotton candy 30 compressed in this manner is cut into a constant size by a cutter 600 while being transferred by a conveyor 500.

The cotton candy 30 which is compressed and cut in a sheet shape with a constant size in this manner may be stably distributed and sold in a manner of being inserted in a predetermined package and sealed. It is desirable that the interior of the package is filled with nitrogen or air during the packing operation so that the quality of the product is not degraded due to an external force exerted thereon during a distribution thereof.

In the method of manufacturing the cotton candy according to the preferred embodiment of the invention, the fatty matter is added to all the cotton candy body 11 and the plurality of sugar particles 20, but the invention is not limited thereto. The fatty matter may be added to any one of the cotton candy body 11 and the plurality of sugar particles 20.

Further, when the fatty matter is added to the cotton candy body 11, as described above, the fatty matter may be added to the sugar 10 which is a raw material of the cotton candy body 11, and the fatty matter may be added to the sugar solution obtained by melting the sugar 10.

Then, the process of compressing and cutting the cotton candy 30 in a sheet shape with a predetermined thickness may be selectively conducted in accordance with a long-term distribution and a sales request. The cotton candy 30 manufactured without the compressing and cutting process may be appropriately massed and be wrapped around sanitary chopsticks or the like to be sold and eatable on site.

As described above, according to the cotton candy and the manufacturing method thereof of the invention, since the plurality of sugar particles 20 is scattered in the cotton candy body 11, it is possible to enjoy high-quality taste and unusual texture obtained by the harmony between the cotton candy body 11 and the sugar particles 20 when eating the cotton candy. Since one or more of the cotton candy body 11 and the sugar particles 20 contain the fatty matter, the plurality of sugar particles 20 is fixed to the cotton candy body 11 through adhesiveness thereof while being evenly scattered inside the cotton candy body 11. Accordingly, since it is possible to prevent the plurality of sugar particles 20 from being separated from the cotton candy body 11 so that they are not biased in a predetermined direction during the distribution of the cotton candy 30, it is possible to normally maintain the high product quality. Also, since it is possible to effectively prevent the sugar particles 20 from being separated from the cotton candy body 11 so that they are not dropped therefrom while eating the cotton candy, it is possible to enjoy the taste and texture obtained by the harmony between the cotton candy body 11 and the sugar particles 20 throughout the eating time and effectively prevent the eating space from being messed up by the sugar particles 20 dropped thereto.

While the specific examples of the invention have been described in detail as above, it is apparent that various modifications and corrections can be made within the scope of the technical spirit of the invention by the ordinary-skilled person of the art, and it is certain that these modifications and corrections are included in the appended claims.

1. A cotton candy comprising:
a cotton candy body which is formed in a manner such that sugar solution formed by melting sugar which is one of drawn out and sprayed in a fiber shape and is cooled; and
a plurality of candy particles which is scattered inside the cotton candy body,
wherein at least one of the cotton candy body and the plurality of candy particles contain an edible fatty matter, and the plurality of candy particles is fixed to the cotton candy body by adhesiveness of the edible fatty matter so as not to be separated therefrom.

2. The cotton candy according to claim 1, wherein the edible fatty matter is coated on the outer peripheral surfaces of the plurality of candy particles when the fatty matter is contained in the plurality of candy particles.

3. The cotton candy according to claim 1, wherein the edible fatty matter is coated on the outer peripheral surfaces of the plurality of candy particles in the form of a liquid intermediate formed by mixing a predetermined edible matter with the fatty matter when the fatty matter is contained in the plurality of candy particles.

4. The cotton candy according to claim 1, wherein the plurality of candy particles is provided as a plurality of carbonated candy particles formed by mixing carbon dioxide with the candy particles so as to generate carbon dioxide when contacting moisture.

5. The cotton candy according to claim 1, wherein the cotton candy body is compressed and cut in a sheet shape with a predetermined thickness.

6. The cotton candy according to claim 1, wherein the fatty matter is contained in the cotton candy body and the plurality of candy particles by 5 wt % to 10 wt %.

7. A method of manufacturing a cotton candy, comprising:
forming a sugar solution by melting sugar;
adding an edible fatty matter to a plurality of candy particles; and
forming the cotton candy by inputting the plurality of candy particles to the sugar solution that is one of drawn out from a minute hole in a fiber shape and sprayed from a rotary disc.

8. The method of manufacturing the cotton candy according to claim 7, further comprising:
adding the edible fatty matter to the sugar solution.

9. The method of manufacturing the cotton candy according to claim 7,
wherein adding the edible fatty matter to the plurality of candy particles comprises coating the edible fatty matter on the plurality of candy particles.

10. The method of manufacturing the cotton candy according to claim 7, wherein adding the edible fatty matter to the plurality of candy particles comprises coating the edible fatty matter on the plurality of candy particles in the form of a liquid intermediate formed by mixing the edible fatty matter with a predetermined edible matter.

11. The method of manufacturing the cotton candy according to claim 7, wherein forming the cotton candy comprises forming the cotton candy by inputting the plurality of candy particles to the sugar solution drawn out from the minute hole in connection with a bent passage.

12. The method of manufacturing the cotton candy according to claim 7, further comprising:
compressing and cutting the cotton candy in a sheet shape with a predetermined thickness.

13. The method of manufacturing the cotton candy according to claim 7, wherein the edible fatty matter is added to the cotton candy by 5 wt % to 10 wt %.

14. A method of manufacturing a cotton candy, comprising:
adding an edible fatty matter to sugar;
forming a sugar solution by melting the sugar; and
forming the cotton candy by inputting the plurality of candy particles to the sugar solution which is one of drawn out from a minute hole in a fiber shape and sprayed from a rotary disc.

15. A method of manufacturing a cotton candy, comprising:
forming a sugar solution by melting sugar;
adding an edible fatty matter to the sugar solution; and
forming the cotton candy by inputting the plurality of candy particles to the sugar solution which is one of drawn out from a minute hole in a fiber shape and sprayed from a rotary disc.
